(19) United States
(12) Patent Application Publication
(10) Pub. No.: US 2009/0150983 A1
(43) Pub. Date: Jun. 11, 2009

(54) SYSTEM AND METHOD FOR MONITORING HUMAN INTERACTION

(75) Inventors: Ashutosh SAXENA, Ahmedabad (IN); Kumar SURNI, Chennai (IN)

Correspondence Address: Workman Nydegger;1000 Eagle Gate Tower, 60 East South Temple, Salt Lake City, UT, 84111, US

(73) Assignee: INFOSYS TECHNOLOGIES LIMITED, BANGALORE (IN)

(21) Appl. No.: 12/197,951

(22) Filed: Aug. 25, 2008

(30) Foreign Application Priority Data
Aug. 27, 2007 (IN) 1907/CHE/2007

(51) Int. Cl. H04L 9/32; G06F 21/00

(52) U.S. Cl. 726/7

(57) ABSTRACT

A method and system to authenticate human interactive proof (HIP) are described here. In response to a request from a web server, a motion random HIP in the form of motion-captcha is generated. The web server can then display the generated the motion random HIP in a requested web page. The web page is accompanied with a request from the user to provide the response for the generated motion captcha. After evaluation and verification of response received from the particular user, the authentication system determine whether the response to the HIP challenge is from human or from other source like computer software scripted agent.

### TECHNICAL FIELD

The present technique relates to authenticate human interactive proof (HIP) using a motion random HIP and more specifically using Motion-Captcha techniques as a human interactive proofs (HIP).

### BACKGROUND

The advent of global communications networks such as the Internet etc has presented commercial opportunities for reaching vast numbers of potential customers. With that, it has also brought a challenge to service provider to prevent automated access by a computer but provide access to a person. Thereof, many attempts have been made to ensure human interactive proof For example in one scheme, an image of an animal, a household item, a flower, etc stored in a database is randomly picked up and provided to the user. The user is requested to respond the image, for example what the image is, or the shape of the image etc. Thereafter, the response is compared with stored value and authentication of user is decided.

In another scheme, a set of texts is randomly selected from a dictionary and presented to the user as an image in jpeg or gif format. These images may have distortion and they are created at the server randomly based on some logic. These texts based images, also called captcha, can be recognized and reproduced correctly by the user. The most frequently used kind of captcha is the Gimpy captcha. There are many more kinds of captcha's other than Gimpy captcha such as, Bongo, Pix, Eco, etc. captcha's are used to ensure HIP. The user is requested to type the text in the box and forward back to server. The server, thereafter, compares the response value with stored value and authenticates the user thereof.

However, the captcha based authentication method also suffers some setbacks. These types of captchas are static in nature, and can be snapped. Once it is snapped and fed to the OCR device, the information presented in the captcha is known, i.e., the captcha has got broken.

Thus, there is a need of an improved technique for authenticating human interaction proof and preventing the security threat from bots and computer programs.

### SUMMARY OF THE INVENTION

The summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one embodiment of the technique, a method to authenticate a human interactive proof is described. The method involves generating of a motion random HIP by a HIP generator module and communicating the generated motion random HIP by a communicating module. The user is displayed generated motion random HIP at his machine and is requested to enter the details of the generated motion random HIP shown to him. Upon receiving the response from the user, an authenticating module compares the response value and authenticate whether the user is a person or a machine. Based on the confirmation, a user may render access or prohibited thereof.

In another embodiment of the technique, a system for HIP is disclosed. The system includes a generating module to generate a motion random HIP being forwarded to the client machine; a communicating module, for example internet, to communicate the generated motion random HIP and to receive response of the user thereof; and a authenticating module to compare the response of user with the forwarded motion random HIP.

In yet another embodiment of the technique, a method of generation of motion random HIP is described. The method involves receiving a request for access to the account from the client machine of a user. The client machine hits the server computing machine and the motion random HIP generating module thereof. The generating module selects a HIP randomly and provides motion or animation to it using an algorithm thereof. The generated motion random HIP is presented to the user's client machine thereof.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a system illustrating the interaction between a user, a client and a server computing system to login into account using motion captcha as an authentication mode, according to one embodiment of the technique;

FIG. 2 is a flow diagram illustrating a method of client request to the server computing system and the processes at the server computing system to generate the captcha image and the server computing system response to the user call according to one embodiment of the technique;

FIG. 3 is a flow diagram illustrating client response and interpretation of the captcha image to the server computing system and the server computing system response in turn according to one embodiment of the technique;

FIG. 4 is a block diagram illustrating an example of a captcha table when a new captcha is displayed to the user every single time wherein the captcha table is maintained at server computing table according to one embodiment of the technique;

FIG. 5 is a block diagram showing an environment in which the client machine is posed with the motion captcha challenge according to one embodiment of the technique;

FIG. 6 is depicting an exemplary example of motion captcha at client machine according to one embodiment of the technique; and

FIG. 7 is a system illustrating a generalized computer network arrangement, according to one embodiment of the technique.

### DETAILED DESCRIPTION

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the systems and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

As will be appreciated by people skilled in the art, to best understand the present invention it is important to be familiar with the definition in which it is used:

“User” in the present technique represents to any person or entity desiring to access to some-kind of protected service or application (e.g., opening of web-based new account, access to available web-based account, etc.)

“Client machine” or “Computer system” or “User machine” or “User system” in the present technique represents personal computers, server computers, hand-held device or laptop devices, multiprocessor systems, microprocessor-based systems, network PCs, mobile devices, personal digital assistants, smart phones, digital cameras, kiosks, ATM and so on.

“Interface” or “User interface” in the present technique represents interface of “Client machine” or “Computer system” or “User system” or “User machine”.

“Server computing system” or “Server computing machine” represents a server application or applications, including application server or web server or databases or generating module or authenticating module or combinations thereof and other necessary hardware or software components, to facilitate secure access to the server.

“Generating module” in the present technique represents a stand alone unit or a part of server computing system.

“Communicating module” in the present technique represents a stand alone unit or as a part of server or combinations of both that is provided to connect user's client machine with server computing system through a network.

“Network” in the present technique represents internet or local area network, a wide area network, a point-to-point dial-up connection, and the like.

“Authenticating module” in the present technique represents a stand alone unit or a part of server computing system.

“Account” in the present technique represents any online account, for example email account, online bank account, etc., requisite by the user wherein the account is maintained at service provider end.

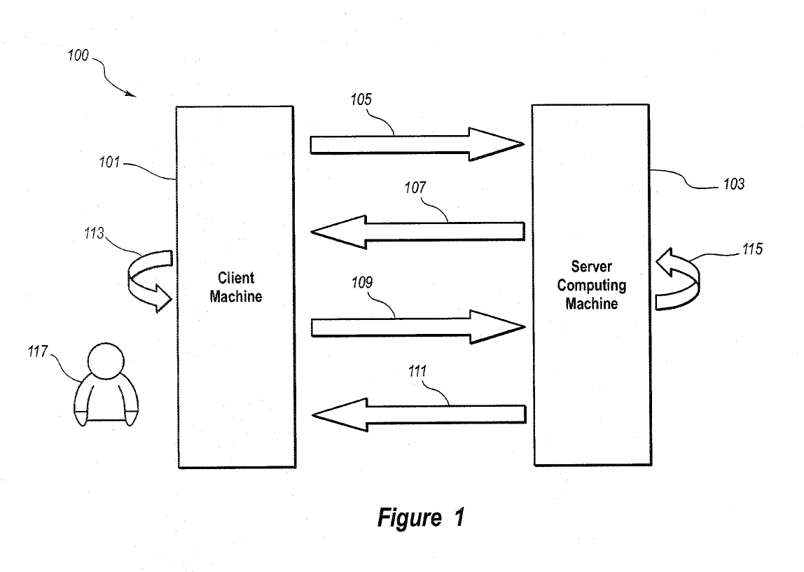

Referring to the figures, FIG. 1 is a block diagram of a system 100 illustrating the interaction between a user 117, a client machine 101, and a server computing system 103 to login into user's account using motion random HIP as an authentication mode, according to one embodiment of the technique. Initially, the user 117 using the client machine 101 gets to the service provider website and requests for the access to his account to perform the desired transaction as indicated by reference numeral 105.

Subsequently, the server computing system 103 of service provider, which has no information regarding the user trying to login at this moment, in order to confirm the end user to be a human or a machine (i.e., an auto generated program or software or robot trying to login), throws out a challenge in the form of motion random HIP to the user's machine 101 and if the end user is able to solve the challenge successfully along with his or her login credentials, the server computing system 103 provides access to his or her account. As soon as a request to access to account hits the server computing system, the code in the server computing system 103 gets executed to generate a motion random HIP wherein the motion random HIP is an animated captcha (also called as motion captcha due to its dynamism) wherein the process of generation of motion random HIP is represented by reference numeral 115. The motion captcha is generated in any of the schemes defined on the server computing system 103 at random. The motion captcha generated on the fly is a unique one; therefore, the user is not able to predict the motion captcha appearance and its scheme. The motion captcha can be a numeral or alphabet or alphanumeric values or image or picture or combinations thereof, wherein the motion captcha may vary in shape or size or dimension or color or distortion or background or texture or combinations thereof and it is dynamically created which is not an image on the web browser so that no one could save it or decrypt the characters out of it. This makes the motion captcha a stronger one in its approach to safeguard the authentication of users from that of self running programs and bots.

In next step, the server computing system 103 returns the control back to the client's machine or gives a response to the client's machine 101 request through a communicating module as indicated by reference numeral 107. This response contains the login page along with the animated captcha. Prior to sending the response, a captcha server table is created for every other user request wherein the captcha server table has option to store some information such as user IP address, captcha ID for every individual user, and the individual scheme used for each motion captcha provided to each user.

Following in the process, the client machine 101 is displayed with the motion captcha details embedded into the login page wherein process of displaying of motion random HIP is indicated by reference numeral 113. The user, if a human, can easily understand the interpret the information provided in the form of motion captcha and enter his or her response thereof, but in case it's an automated program or a bot or any self generated answer by brute force methodology trying to login into the user ID of some other person will get defeated. The motion captcha is designed in such a manner that it will be dynamic and understandable to human eyes alone. The motion captcha cannot be captured by the OCR's since it is dynamic in nature and cannot be captured in a glance. Similarly, bots or automated programs or any self generated answer by brute force methodology are also not able to interpret captcha because of dynamic nature of it while the user if he is a person can easily identify the motion captcha and interpret it thereof.

In next step, the user 117 upon successful identification of the details provided in the motion captcha enters the response in the response box along with his credentials i.e., login ID, password, etc. and sends his response to the server computing system wherein the response of the user 117 is indicated by reference numeral 109. In case of any automated bots or programs will not be able to identify the motion captcha and hence will not be able to input them in the response box at all or will enter them wrong.

Furthermore, the user's response, as represented by reference numeral 109, is provided to server computing system wherein server computing system is an authenticating module used for authenticating the user's response. The authenticating module validates upon the information provided in the form of motion captcha entered by the user and the actual information provided in form of the captcha, and also the login and password provided by the user. If the user credentials match and also does the captcha input matches with the original one, the user is given the authentication to his or her account and access to his or her account thereof. If the response received from the client's machine does not match with the stored value, access of the account is denied. Therefore, according to one embodiment of the technique, the decision of rejection or acceptance of access (indicated by reference numeral 111) to the account, depends upon the evaluation and verification of the motion captcha response apart from the user's credentials. This method eliminates the process of automated entry by bots or robots or computer programs or any self generated answer by brute force methodology.

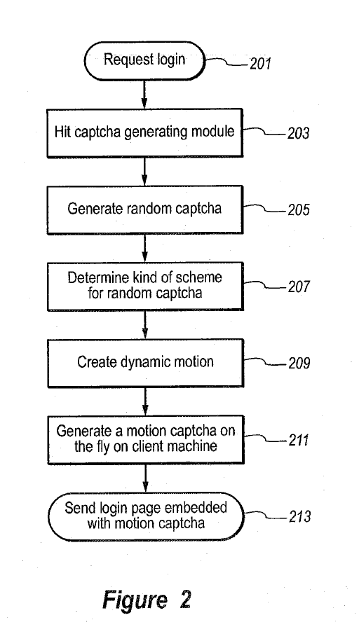

FIG. 2 is a flow diagram illustrating a method of client request to the server computing system and the processes at the server computing system to generate the captcha image and the server computing system response to the user call according to one embodiment of the technique. According to one embodiment of the technique, server computing system is a generating module to generate a motion random captcha. The method starts with client request (block 201) for login into his account.

Subsequently in step 203, on hitting the server computing system (i.e., generating module), the server computing system allocates a thread to the request and starts the series of processing steps. As represented in step 205, the generating module generates a random captcha by a random mathematical function and operates upon it based on the algorithm. Thereafter in step 207, the generating module decides upon the kind of scheme based on a random function that has to be displayed for the motion captcha. The various schemes have been dealt with in detail in the other sections which explains a few of the types of schemes and their various functionalities in avoiding bots in entering authenticated servers. In step 209, the generated random captcha is put in the scheme decided upon in step 207 and a dynamic motion captcha is generated at the generating module side. The dynamic captcha may be a numeral or alphabet or alphanumeric values or image or picture or combinations thereof, and may vary in shape or size or dimension or color or distortion or background or texture or combinations thereof. The motion captcha generated in the previous block (i.e. in block 209) is sent to the client machine on the fly (block 211), embedded with other login information requisition details. Therefore, the server computing system responds to the user request by providing a login page embedded with motion captcha along with other login credential to the client machine.

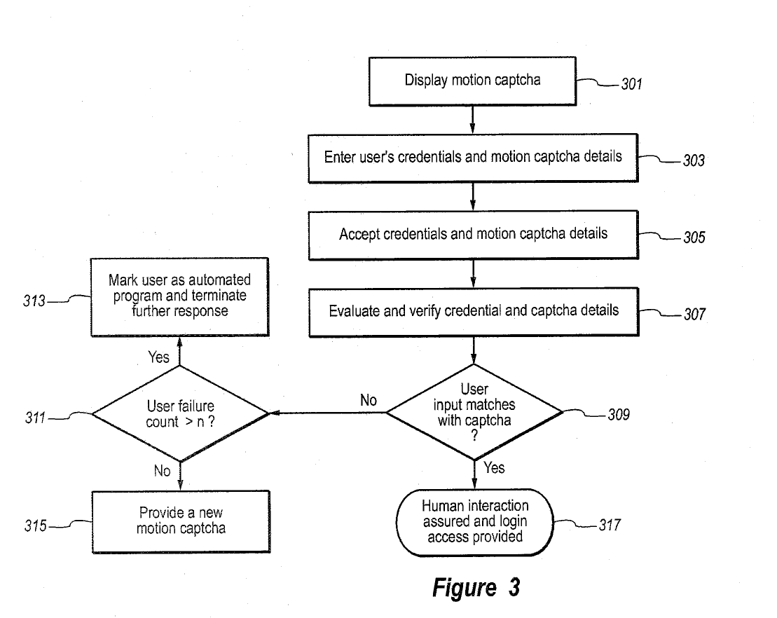

FIG. 3 is a flow diagram illustrating client response and interpretation of the captcha image to the server computing system and the server computing system response in turn according to one embodiment of the technique. The method starts by displaying motion captcha on the client machine on the fly with any one of the schemes as decided upon by the generating module (block 301). This login page contains the vacant box for the user login credential details such as user ID, password, etc., and for details of captcha to be filled with. The user enters the required details such as the user ID, password, etc. and the captcha details in the required field (block 303). The user if a person can easily recognize, understand and interpret the captcha details though it is being dynamic in nature. But, for example, the end user is a bots or robots or computer programs or any self generated answer by brute force methodology cannot understand and interpret the captcha details due to its complex appearance and dynamic motion. The server computing system receives the user response containing credential information such as user's ID, password etc., and the captcha details (block 305). The step 307 represents validating process of user where the server computing system evaluates and verifies response received for the motion captcha and for credentials such as the user ID, password etc. from the user's machine. The user input value validation is checked to be true or not and based on that the user is given the valid user authentication for his/her account or denied (block 309). If the response received from client machine matches with the motion captcha details, the user is authenticated as a person and access is provided (block 317) thereof. If the user response differs, access is restricted for the moment and a new motion captcha (block 315) is provided to the user's machine. The number of failure attempts of the user response is checked for particular value n attempts (block 311) as decided upon by the server computing system and if the failure attempts exceed the particular value n the user to be safe is denied of the service and marked as an automated program (block 313).

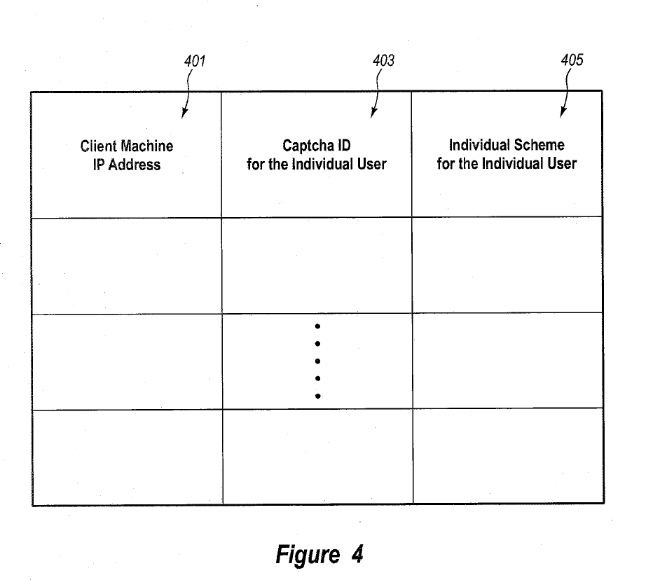

FIG. 4 is a block diagram illustrating an example of a new captcha displayed to the user every single time wherein captcha table is maintained at server computing system according to one embodiment of the technique. By way of example the captcha table is illustrated as comprising a plurality of records, each record comprising a user computer IP address field (block 401), the captcha ID for the individual user (block 403), and the individual scheme type of the particular user (block 405). The user IP address field (block 401) identifies and notes down the IP address of each and every client machine that requests for the login page. The captcha ID for the individual user's field (block 403) saves the session ID for each captcha that has been generated for that session of the user request in order to compare with the captcha details response entered by the user. Individual scheme type for every user (block 405) field saves the kind of scheme used by the generating module to display the captcha to the client. Based on the scheme provided to the user of the n number of schemes, a value is stored in the table so as to get an idea of the kind of scheme when the user input for the captcha details is validated. Therefore, the user is identified based on the credentials (e.g., login identification and password/pin, etc.) entered by the user and the response provided for the motion captcha thereof.

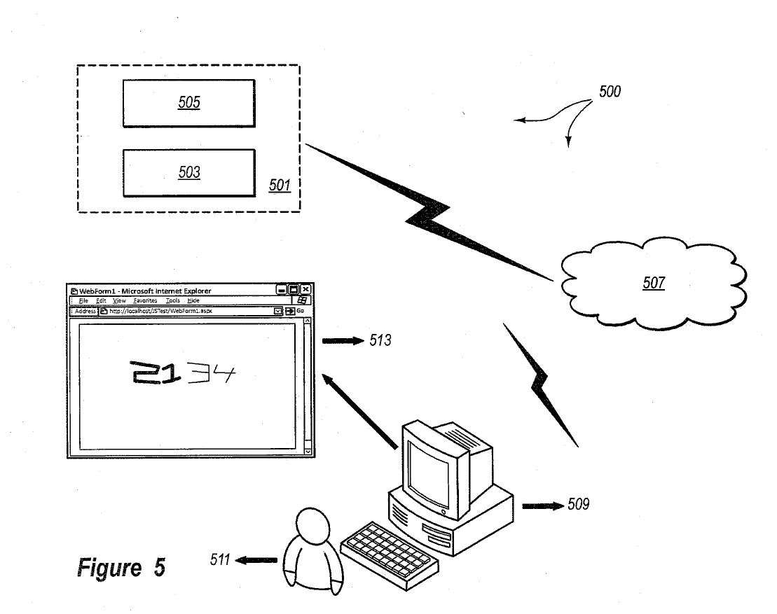

FIG. 5 is a high-level block diagram showing an environment in which the client machine is posed with the motion captcha challenge according to one embodiment of the technique. The various events in the process of user login into authorized server and using its resources according to some embodiments. As depicted, the environment comprises at least one server computing system 501, at least one generating module 503, at least one authentication module 505 wherein the generating module and/or the authentication module may be a part of the server computing system or may be separate units, at least one communication module 507 e.g., a network system such as internet, at least one client machine 509 through which the user 511 uses to connect to the server computing systems via network system 507, the user 511, and the application containing the motion captcha 513 displayed on the client machine interface.

In one of the embodiment, the user 511 requests for the access to his account available at remote server computing system 501 through his client machine 509. The client machine 509 is connected with the remote server computing system via the communication system, for example by internet 507 though not exhaustive. In response to user's machine, the server computing system provides a login page where the login page is embedded with motion captcha. The motion captcha is generated by the generating module 503. The login page further comprises one or more boxes to enter user's credentials such as login ID, password etc. and/or details of the motion captcha. Once the response is received from the user, the authenticating module, after accepting the response, initiates process for evaluation and verification the user's response for the motion captcha. If the user's response matches with the motion captcha details stored in captcha table, the user is authenticated as human and access to the said account is provided. If the user response faults from the captcha details stored in captcha table, a new motion captcha will be provided and the user will be requested for the response for the same. Again, if the user's response is incorrect, a new motion captcha will be forwarded, the process will be continued for ‘n’ times where value of ‘n’ is decided by server computing system. If the number of incorrect responses exceeds ‘n’ value, the user is declared as automated program or bot or robot and the system invalidate the user and access to the said account thereof.

### Exemplary Example of Technique

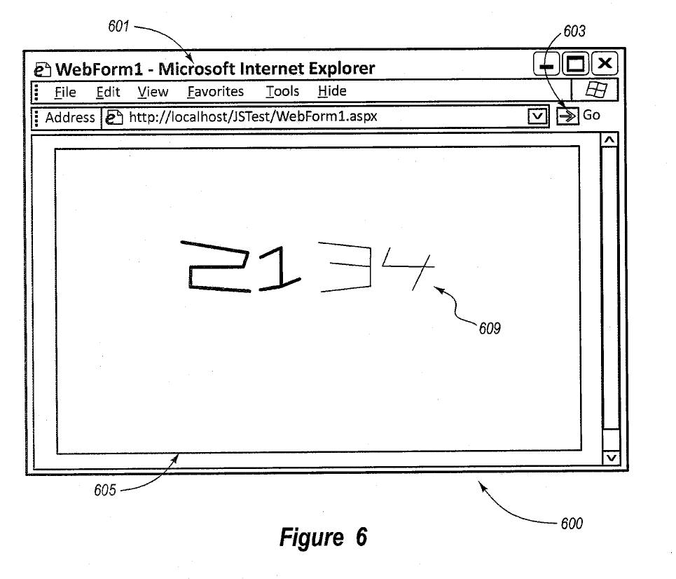

FIG. 6 displays a diagram showing a motion captcha according to one of the embodiments of the technique. The web browser 601 shown in the display diagram contains motion captcha 609 in the form of lined characters and 603 shows the address bar on the browser having the website name of the bank or other server whose server resources have been requested by the user. In another embodiment of the technique, the motion captcha 609 includes, but not limited to, numeral or alphabet or alphanumeric values or image or picture or combinations thereof, wherein the motion captcha varies in shape or size or dimension or color or distortion or background or texture or combinations thereof. Furthermore, the image or picture of the motion captcha includes, but not limited to, an image of an animal such as cat or dog etc., or an article such as chair or table etc., or an image of numeral or alphabet or alphanumeric values. In another embodiment of the technique, motion captcha 609 may vary in shape or size or dimension or color or distortion or background color or texture or combinations thereof.

Available HIP challenges, like Gimpy captcha such as, Bongo captcha, Pix captcha, Eco captcha, etc. are developed on the hard Artificial Intelligence problems. Such image based or text based captcha are static and can be snapped and therefore can be broken using ‘recognition and segmentation’ technique. Bots or OCR or other software programs/techniques capable of recognizing static text and/or image can extract the information provided from such static captcha and, therefore, such kinds of the captcha are weak and breakable. As discussed in the present technique, a motion random HIP is more particularly a motion captcha which is an animated form of original captcha. The animation includes the movement of the original captcha or some sort of dynamic activity (non repetitive) of the original captcha such that the end user is not able to have a look at the entire motion captcha in a single shot. If such an animation is done the OCR cannot be fed with a single image containing the entire snap of the captcha image for further image processing activities to break the captcha. In this process of animating the original captcha one raises the bar for the OCR's to first integrate a few snaps of the dynamic image in order to have a complete view of the captcha image. If this is done further image breaking processes are hardened thereof. Thus this technique ensures an extra security bar to avoid automated computer programs from taking over the authenticated resources and credentials. Similarly, bots or robots or automated programs or any self-generated answers by brute force methodology are also not able to recognize the original captcha because of dynamic nature of the original captcha.

### Exemplary Computing Environment

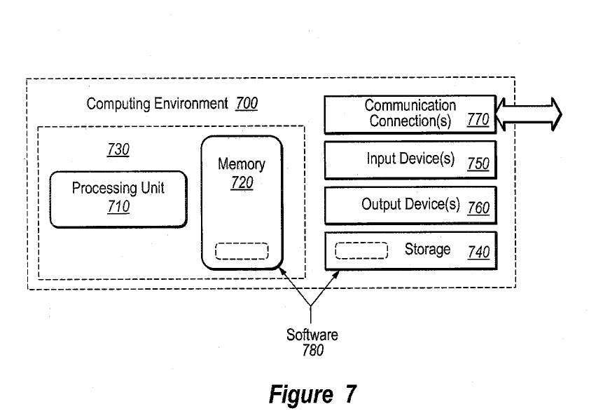

One or more of the above-described techniques can be implemented in or involve one or more computer systems. FIG. 7 illustrates a generalized example of a computing environment 700. The computing environment 700 is not intended to suggest any limitation as to scope of use or functionality of described embodiments.

With reference to FIG. 7, the computing environment 700 includes at least one processing unit 710 and memory 720. In FIG. 7, this most basic configuration 730 is included within a dashed line. The processing unit 710 executes computer-executable instructions and may be a real or a virtual processor. In a multi-processing system, multiple processing units execute computer-executable instructions to increase processing power. The memory 720 may be volatile memory (e.g., registers, cache, RAM), non-volatile memory (e.g., ROM, EEPROM, flash memory, etc.), or some combination of the two. In some embodiments, the memory 720 stores software 780 implementing described techniques.

A computing environment may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The storage 740 may be removable or non-removable, and includes magnetic disks, magnetic tapes or cassettes, CD-ROMs, CD-RWs, DVDs, or any other medium which can be used to store information and which can be accessed within the computing environment 700. In some embodiments, the storage 740 stores instructions for the software 780.

The input device(s) 750 may be a touch input device such as a keyboard, mouse, pen, trackball, touch screen, or game controller, a voice input device, a scanning device, a digital camera, or another device that provides input to the computing environment 700. The output device(s) 760 may be a display, printer, speaker, or another device that provides output from the computing environment 700.

The communication connection(s) 770 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 500, computer-readable media include memory 720, storage 740, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

We claim:

1. A method for authenticating a human interactive proof (HIP) comprising:
generating at least one motion random HIP by a HIP generator purporting to be used by at least one user;
communicating the generated motion random HIP by a communicator module to the at least one user;
displaying the generated motion HIP to the at least one user;
inputting the generated motion random HIP by the at least one user;
receiving information from the at least one user; and
authenticating the at least one user by comparing the user's input with the generated motion HIP by an authenticating module.

2. The method as recited in claim 1, wherein motion random HIP is in form of motion captcha.

3. The method as recited in claim 1, wherein the at least one motion random HIP is generated by at least one generating module.

4. The method as recited in claim 1, wherein the at least one motion random HIP is rendered by at least one communicating module.

5. The method as recited in claim 1, wherein the at least one motion random HIP is displayed at the interface to the at least one user.

6. The method as recited in claim 1, wherein the information provided in the form of the at least one motion random HIP is entered by the at least one user.

7. The method as recited in claim 1, wherein the information is received by the at least one authenticating module.

8. The method as recited in claim 1, further comprising establishing the HIP by authenticating the at least one user by evaluating and verifying the user's input.

9. The method as recited in claim 1, wherein authenticating the at least one user is executed by at least one authenticating module.

10. The method as recited in claim 1, wherein the generated motion random HIP in the form of motion captcha is selected from at least one of the numeral or alphabet or alphanumeric values or image or picture or combinations thereof, wherein the motion captcha varies in shape or size or dimension or color or distortion or background or texture or combinations thereof.

11. The method as recited in claim 1, wherein the at least one motion random HIP is implemented as web-based services offered on internet or intranet or both.

12. The method as recited in claim 1, wherein the at least one motion random HIP is implemented in a form of executable software application.

13. A system for authenticating a human interactive proof (HIP) comprising:
at least one motion HIP generator module adapted to generate at least one motion HIP;
at least one communicator module adapted to transmit the at least one motion HIP at client machine; and
at least one authenticator module adapted to authenticate user's input.

14. The system as recited in claim 13, wherein the at least one motion random HIP generator is adapted to generate the at least one motion random HIP purporting to be used by at least one user.

15. The system as recited in claim 13, wherein the communicating module is adapted to transmit the motion random HIP purporting to be used by at least one user.

16. The system as recited in claim 13, further comprising at least one interface is adapted to display or receive or input or the combinations thereof the at least one motion random HIP.

17. The system as recited in claim 13, wherein the at least one authenticating module is adapted to evaluate and verify the user's input and thereafter establishes the true user.

18. A method of generating of motion HIP comprising:
receiving a request for a login page from at least one user's system; and
generating at least one motion random HIP by at least one generating module purporting to be used by the at least one user;

19. The method as recited in claim 18, wherein the request received initiates processing of the at least one server to provide the at least one login page.

20. The method as recited in claim 18, further comprising the login page is provided, wherein the login page comprises the at least one motion random HIP being displayed at the user's system.

21. The method as recited in claim 18, wherein the at least one motion random HIP is generated by the at least one generating module.

22. The method as recited in claim 18, further comprising communicating the at least one motion HIP randomly by the at least one communicating module to the at least one user immediately after generating.

23. The method as recited in claim 18, wherein the generated motion HIP in the form of motion captcha is selected from at least one of the numeral or alphabet or alphanumeric values or image or picture or combinations thereof, wherein the motion captcha varies in shape or size or dimension or color or distortion or background or texture or combinations thereof.

24. A computer program product comprising a computer usable medium having a computer readable program code embodied therein for generating a motion HIP for authenticating a human interactive proof comprising:
a program code adapted for generating at least one motion random HIP by a generating module;
a program code adapted for communicating motion random HIP by a communicating module;
a program code adapted for displaying the generated motion HIP to the at least one user;
a program code adapted for inputting the generated motion random HIP; receiving information from the at least one user; and
a program code adapted for a program code adapted for authenticating the at least one user by an authenticating module.

25. The computer program product of claim 24, wherein the program code is adapted to generate the at least one motion random HIP by a generating module wherein the motion random HIP is rendered by at least one server and is displayed at login page to the at least one user.

26. The computer program product of claim 24, wherein the program code is adapted for communicating the at least one random HIP by a communicating module immediately after generation which is being rendered by at least one server and displayed at login page to the at least one user.

27. The computer program product of claim 24, wherein the program code is adapted for displaying the at least one random HIP communicated by the communicating module immediately after generation to the at least one user.

28. The computer program product of claim 24, wherein the program code is adapted to accepting the input provided in the form of the motion random HIP to the at least one user.

29. The computer program product of claim 24, wherein program code is adapted to authenticate the true user by evaluating and verifying the inputs provided by the at least one user and thereafter the true user is established.
